(19) United States
(12) Patent Application Publication
(10) Pub. No.: US 2024/0175495 A1
(43) Pub. Date: May 30, 2024

(54) MAGNETIC FLUID SEAL

(71) Applicant: MAGNEX CO., LTD., Cheongju-si (KR)

(72) Inventors: Yong Woon KWAK, Cheongju-si (KR); Jeong Hui HONG, Cheongju-si (KR); Je In JEON, Chungcheongbuk-do (KR); Gil Ho LEE, Cheongju-si (KR)

(73) Assignee: MAGNEX CO., LTD., Cheongju-si (KR)

(21) Appl. No.: 17/994,418

(22) Filed: Nov. 28, 2022

(30) Foreign Application Priority Data
Nov. 25, 2022 (KR) 10-2022-0160515

(51) Int. Cl. F16J 15/43

(52) U.S. Cl. CPC F16J 15/43

(57) ABSTRACT

One embodiment of the present disclosure provides a magnetic fluid seal including a rotating shaft, a pole piece disposed to surround the rotating shaft, a plurality of trenches formed on any one of the rotating shaft and the pole piece, a magnetic fluid provided between the other one of the rotating shaft and the pole piece and at least one of ends of the plurality of trenches, a blocking member provided in a space between the plurality of trenches, and a permanent magnet configured to apply a magnetic force to the magnetic fluid.

### FIELD OF THE INVENTION

The present disclosure relates to a magnetic fluid seal which can protect a magnetic fluid using a blocking member and improve sealing performance while maintaining a structure of a general magnetic fluid seal.

### DISCUSSION OF RELATED ART

In apparatuses for transmitting power to various types of vacuum apparatuses that should be maintained in a vacuum state, magnetic fluid seals have been used to address disadvantages of existing mechanical sealing technologies using an O-ring or the like.

In this case, a magnetic fluid is directly exposed to heat or foreign matter such as a process gas or powder generated during a process in a vacuum chamber. Therefore, there is a problem that the magnetic fluid is deteriorated or contaminated and the sealing performance is degraded.

Also, there is a problem that, due to a pressure difference between a vacuum side and an atmospheric side, magnetic fluid loss occurs and the sealing performance is degraded when the magnetic fluid is used for a long period of time.

In order to prevent such problems, various attempts have been made to prevent direct contact between a magnetic fluid and heat or foreign matter such as a process gas.

### RELATED ART DOCUMENT

### Patent Document

Japanese Unexamined Patent Application Publication No. 2013-1142466

### SUMMARY OF THE INVENTION

### Problem to be Solved

The present disclosure is directed to providing a magnetic fluid seal which can prevent loss of a magnetic fluid and maintain a state thereof using a blocking member and improve sealing performance of the magnetic fluid seal while maintaining a structure of a general magnetic fluid seal.

Objectives of the present disclosure are not limited to those described above, and other unmentioned objectives should be clearly understood by those of ordinary skill in the art to which the present disclosure pertains from this specification and the accompanying drawings.

### Means of Solving the Problem

The present disclosure provides a magnetic fluid seal including a rotating shaft, a pole piece disposed to surround the rotating shaft, a plurality of trenches formed on any one of the rotating shaft and the pole piece, a magnetic fluid provided between the other one of the rotating shaft and the pole piece and at least one of ends of the plurality of trenches, a blocking member provided in a space between the plurality of trenches, and a permanent magnet configured to apply a magnetic force to the magnetic fluid.

In the space formed between the plurality of trenches, a size of a space where the blocking member is provided may be formed larger than a size of another space.

The pole piece may include a first pole piece and a second pole piece provided at both ends of the permanent magnet, and the blocking member may be provided between the first pole piece and the rotating shaft or between the second pole piece and the rotating shaft.

Another embodiment of the present disclosure provides a magnetic fluid seal including a rotating shaft, a pole piece disposed to surround the rotating shaft, a plurality of trenches formed on any one of the rotating shaft and the pole piece, a magnetic fluid provided on the other one of the rotating shaft and the pole piece and ends of the plurality of trenches, a blocking member accommodation groove provided in at least one of the pole piece and the rotating shaft, a blocking member provided in the blocking member accommodation groove, and a permanent magnet configured to apply a magnetic force to the magnetic fluid.

Still another embodiment of the present disclosure provides a magnetic fluid seal including a rotating shaft, a first pole piece disposed to surround the rotating shaft, a second pole piece disposed to surround the rotating shaft, a plurality of trenches formed on any one of the first pole piece and the rotating shaft, a magnetic fluid provided on the other one of the first pole piece and the rotating shaft and ends of the plurality of trenches, a blocking member accommodation groove provided in at least one of the second pole piece and the rotating shaft, a blocking member provided in the blocking member accommodation groove, and a permanent magnet configured to apply a magnetic force to the magnetic fluid.

Yet another embodiment of the present disclosure provides a magnetic fluid seal including a housing, a rotating shaft provided inside the housing, a pole piece disposed to surround the rotating shaft, a plurality of trenches formed on any one of the housing and the rotating shaft, a magnetic fluid provided on the other one of the housing and the rotating shaft and ends of the trenches, a blocking member provided in a space between the plurality of trenches, and a permanent magnet configured to apply a magnetic force to the magnetic fluid.

Yet another embodiment of the present disclosure provides a magnetic fluid seal including a housing, a rotating shaft provided inside the housing, a pole piece disposed to surround the rotating shaft, a plurality of trenches formed on any one of the housing and the rotating shaft, a magnetic fluid provided on the other one of the housing and the rotating shaft and ends of the trenches, a blocking member accommodation groove provided in at least one of the housing and the rotating shaft, a blocking member provided in the blocking member accommodation groove, and a permanent magnet configured to apply a magnetic force to the magnetic fluid.

Yet another embodiment of the present disclosure provides a magnetic fluid seal including a housing, a rotating shaft provided inside the housing, a first pole piece disposed to surround the rotating shaft, a second pole piece disposed to surround the rotating shaft, a plurality of trenches formed on any one of the first pole piece and the housing, a magnetic fluid provided on the other one of the first pole piece and the housing and ends of the plurality of trenches, a blocking member accommodation groove provided in at least one of the second pole piece and the housing, a blocking member provided in the blocking member accommodation groove, and a permanent magnet configured to apply a magnetic force to the magnetic fluid.

### Advantages of the Invention

The magnetic fluid seal according to the embodiment of the present disclosure is capable of improving magnetic fluid loss prevention, state maintenance, and sealing performance of the magnetic fluid seal with a simple process of additionally disposing a blocking member while maximizing the structure of the existing differential fluid seal.

The effects of the present disclosure are not limited to the above-mentioned effects, and effects not mentioned will be clearly understood by those skilled in the art from this specification and the accompanying drawings.

### BRIEF DESCRIPTION OF THE DRAWINGS

FIG. 1 is a view schematically illustrating a structure of a magnetic fluid seal according to a first embodiment of the present disclosure:

FIGS. 2 and 3 are views schematically illustrating modifications of the magnetic fluid seal according to the first embodiment of the present disclosure:

FIG. 4 is a view schematically illustrating a structure of a magnetic fluid seal according to a second embodiment of the present disclosure:

FIG. 5 is a view schematically illustrating a structure of a magnetic fluid seal according to a third embodiment of the present disclosure;

FIG. 6 is a view schematically illustrating a structure of a magnetic fluid seal according to a fourth embodiment of the present disclosure:

FIG. 7 is a view schematically illustrating a structure of a magnetic fluid seal according to a fifth embodiment of the present disclosure; and

FIG. 8 is a view schematically illustrating a structure of a magnetic fluid seal according to a sixth embodiment of the present disclosure.

### DETAILED DESCRIPTION OF EXEMPLARY EMBODIMENTS

Hereinafter, specific embodiments of the present disclosure will be described in detail with reference to the drawings. However, the spirit of the present disclosure is not limited to embodiments proposed herein, and those of ordinary skill in the art who understand the spirit of the present disclosure may easily propose another less advanced invention or another embodiment included within the scope of the spirit of the present disclosure by adding, changing, or omitting an element within the scope of the same spirit. However, these should also be construed as belonging to the scope of the spirit of the present disclosure.

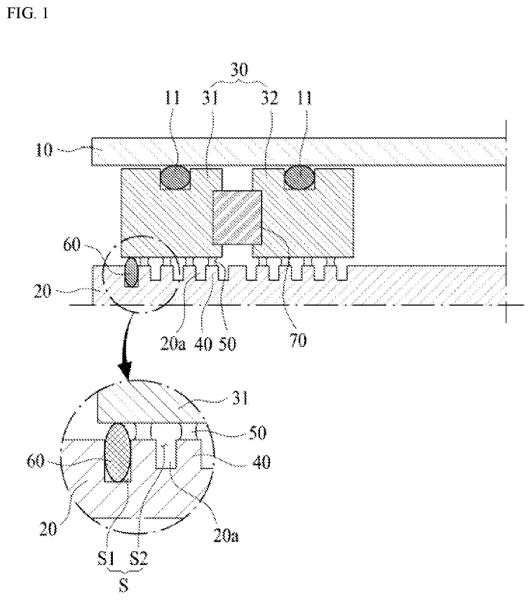

FIG. 1 is a view schematically illustrating a structure of a magnetic fluid seal according to a first embodiment of the present disclosure.

Referring to FIG. 1, a magnetic fluid seal according to the present disclosure is a component which is applied to various vacuum apparatuses relating to semiconductors, liquid crystal displays (LCDs), organic light emitting displays (OLEDs), and solar industries and effectively transmits power while maintaining a sealed state between a vacuum side and an atmospheric side. Specifically, a rotating shaft 20 is provided inside a housing 10, and the rotating shaft 20 is surrounded to form a sealing structure.

Specifically, the magnetic fluid seal according to the present embodiment includes the housing 10, the rotating shaft 20, a pole piece 30, a trench 40, a magnetic fluid 50, a blocking member 60, and a permanent magnet 70. Also, in addition to the above elements, structures, components, and the like of a generally known magnetic fluid seal may be applied in various ways.

The housing 10 forms an exterior of a sealing apparatus, and a space in which the rotating shaft 20 may be accommodated is formed inside the housing 10.

The rotating shaft 20 is an element installed in the space inside the housing 10 and configured to rotate by power supplied thereto.

The pole piece 30 is provided to surround the rotating shaft 20 positioned inside the housing 10 and forms a sealing structure. Specifically, various known sealing structures may be adopted to the pole piece 30 and the housing 10, and in the present embodiment, a sealing structure is formed using an O-ring 11. Also, a sealing structure is formed using the trench 40 and the magnetic fluid 50 between the pole piece 30 and the rotating shaft 20.

The shape of the pole piece 30 and the number thereof may vary according to an adopted magnetic fluid seal structure, and in the present embodiment, two pole pieces 31 and 32 are disposed at both sides of the permanent magnet 70.

The trench 40 may be formed to protrude from at least a portion of the rotating shaft 20 and the pole piece 30 disposed to face each other or may be provided due to a recessed groove being formed. Specifically, in the present embodiment, as a plurality of recessed grooves 20a are formed along the circumference of the rotating shaft 20, a plurality of trenches 40 are formed to protrude along the circumference of the rotating shaft 20. Also, a recessed space S is formed between the trenches.

Generally, the width, height, and form of the trenches 40 and an interval between the trenches 40 are formed in consideration of the type of magnetic fluid and the diameter, rotational speed, or the like of the rotating shaft so that the sealed state is effectively maintained. Specifically, the trenches 40 may be designed according to a condition that the magnetic fluid 50 should effectively maintain a sealed state between an upper portion of the trench 40 and an inner side of the pole piece.

In the present disclosure, the blocking member 60 for prevention of loss of the magnetic fluid 50 and other purposes is provided using at least a portion of the space generated between the trenches 40. That is, loss, deterioration, or the like of the magnetic fluid 50 can be prevented using the space S, which is generated due to the plurality of trenches 40 being formed, and the blocking member 60 having the form of a simple O-ring.

Meanwhile, in a case in which a ready-made product such as an O-ring is used as the blocking member 60, the blocking member 60 may not be inserted into the space between the trenches 40 in some cases, and accordingly, a space into which the blocking member 60 is inserted may be formed to have a size different from a size of another space.

Specifically, in the present embodiment, the space formed between the plurality of trenches 40 may be classified into a first space S1 and a second space S2, and the first space S1 into which the blocking member 60 is inserted may be formed larger than the second space S2.

The blocking member 60 is provided in the space formed between the trenches 40. The material and form of the blocking member 60 are not limited as long as the blocking member 60 may cover a space formed between the rotating shaft 20, the pole piece 30, and a pair of trenches 40, and an O-ring structure may be adopted in consideration of ease of application to actual products.

That is, in the present disclosure, just by the blocking member 60, which has the form of a general O-ring or the like, being provided in a space generally formed as an empty space, it is possible to effectively prevent loss, deterioration, or the like of the magnetic fluid seal.

The magnetic fluid 50 is an element provided between the trench 40 and the rotating shaft 20 or the pole piece 30 facing the trench 40 in order to seal the corresponding portion, and various known magnetic fluids may be applied.

The arrangement and form of various known permanent magnets may be applied to the permanent magnet 70, and in the present embodiment, the permanent magnet 70 is disposed on the pair of pole pieces 31 and 32 to form a magnetic circuit.

That is, in the present embodiment, just by the blocking member 60, which has the form of a general O-ring or the like, being provided in a space generally formed as an empty space, it is possible to effectively prevent loss, deterioration, or the like of the magnetic fluid seal.

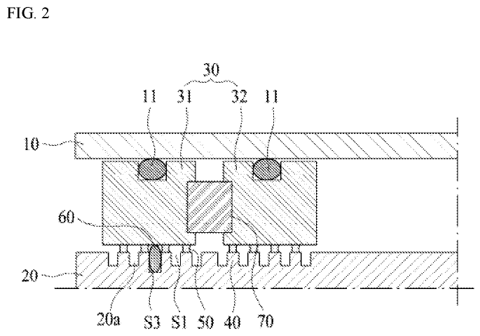

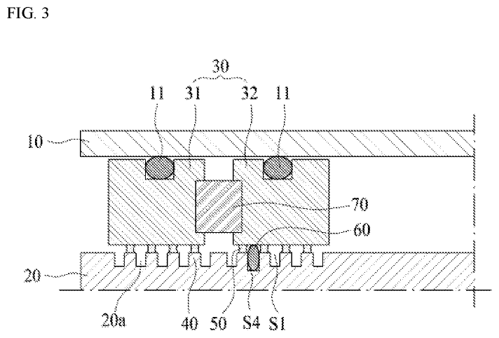

FIGS. 2 and 3 are views schematically illustrating modifications of the magnetic fluid seal according to the first embodiment of the present disclosure.

Referring to FIGS. 2 and 3, a first space disposed between the trenches and in which the blocking member 60 is accommodated may be formed at various positions. As in the first embodiment described above, the first space S1 may be provided between the trenches 40 formed at a front portion of the pole piece 31. Also, as in FIG. 2, a first space S3 may be formed between the trenches formed at an intermediate portion of the pole piece 31, and as in FIG. 3, a first space S4 may be formed between the trenches 40 provided to face any one pole piece 32 of the two pole pieces 31 and 32.

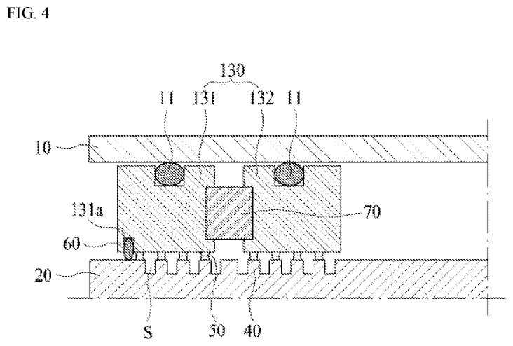

FIG. 4 is a view schematically illustrating a structure of a magnetic fluid seal according to a second embodiment of the present disclosure.

The overall configuration of the magnetic fluid seal of the present embodiment is similar to the first embodiment described above, and differences therefrom will be mainly described below.

Referring to FIG. 4, in the present embodiment, a blocking member accommodation groove 131a in which the blocking member 60 is accommodated is formed as a separate element. That is, although a space between the trenches 40 that is for placing the magnetic fluid 50 is utilized to place the blocking member 60 in the first embodiment, a separate blocking member accommodation groove 131a that is different from the space between the trenches 40 is formed in the present embodiment.

The blocking member accommodation groove 131a may be formed at the foremost portion of a vacuum side to prevent loss of the magnetic fluid 50 into the vacuum side. Also, the blocking member accommodation groove 131a may be formed in the pole piece 30 or formed in the rotating shaft 20, but in the present embodiment, the blocking member accommodation groove 131a is formed as a separate element in a pole piece 131.

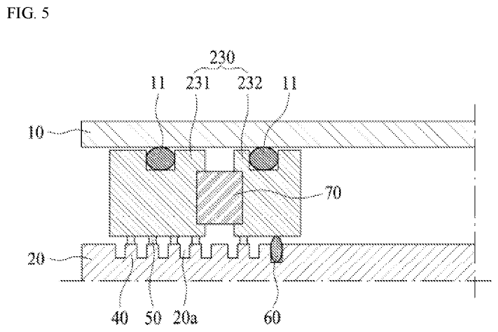

FIG. 5 is a view schematically illustrating a structure of a magnetic fluid seal according to a third embodiment of the present disclosure.

The overall configuration of the magnetic fluid seal of the present embodiment is similar to the embodiments described above, and differences therefrom will be mainly described below.

Referring to FIG. 5, in the present embodiment, two pole pieces 231 and 232 are provided. Also, the blocking member 60 may be provided at only any one of the two pole pieces. Also, the pole piece at which the blocking member 60 is provided may be formed smaller than the pole piece at which the blocking member is not provided, and accordingly, the overall size of the manufactured magnetic fluid seal may be small.

Generally, sealing is performed in multiple layers by the magnetic fluid 50 along the trenches 40. As a result, in the case of the pole piece 232 at which the blocking member 60 is provided, sealing by the magnetic fluid 50 and mechanical sealing using the blocking member 60 are simultaneously performed, and thus, as compared to a case in which sealing is performed only by the magnetic fluid 50, similar sealing performance can be achieved with a smaller number of trenches 40.

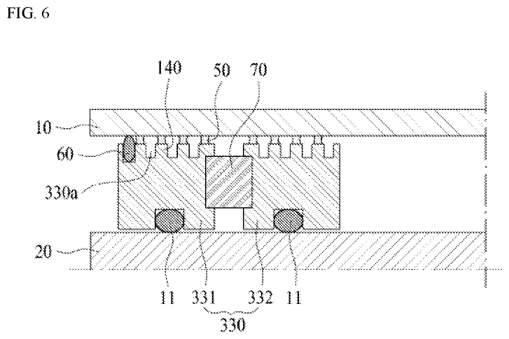

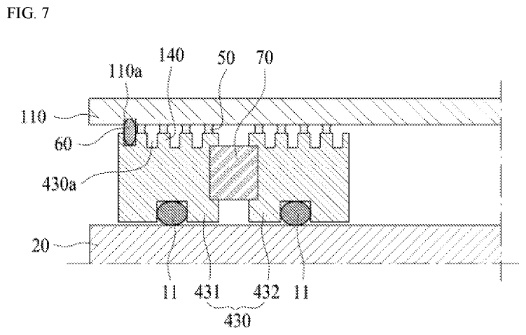

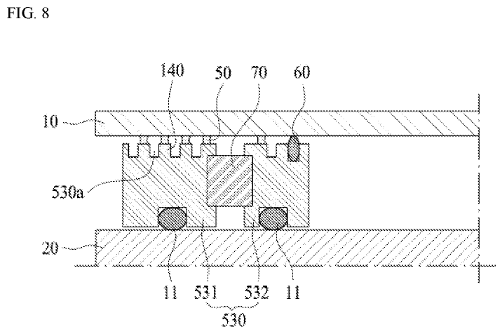

FIG. 6 is a view schematically illustrating a structure of a magnetic fluid seal according to a fourth embodiment of the present disclosure, FIG. 7 is a view schematically illustrating a structure of a magnetic fluid seal according to a fifth embodiment of the present disclosure, and FIG. 8 is a view schematically illustrating a structure of a magnetic fluid seal according to a sixth embodiment of the present disclosure.

Referring to FIGS. 6 to 8, in a magnetic fluid seal, sealing may be performed between an inner side surface of the housing 10 and the pole piece, unlike the structure in which sealing is performed by the magnetic fluid between the rotating shaft 20 and the pole piece as in the first to third embodiments.

That is, referring to FIG. 6, in the fourth embodiment of the present disclosure, a trench 140 is provided between the housing 10 and a pole piece 330. Specifically, in the present embodiment, as recessed grooves 330a are formed along the outer circumference of two pole pieces 331 and 332, a plurality of trenches 140 are formed.

Also, the blocking member 60 is disposed in one of the grooves formed between the plurality of trenches 140 as in the first embodiment described above.

Referring to FIG. 7, in the fifth embodiment of the present disclosure, a trench 140 is provided between a housing 110 and a pole piece 430. Specifically, in the present embodiment, as recessed grooves 430a are formed along the outer circumference of two pole pieces 431 and 432, a plurality of trenches 140 are formed.

Also, in the present embodiment, as in the second embodiment described above, a separate blocking member accommodation groove 110a is formed along the circumference of an inner side surface of the housing 110, and the blocking member 60 is accommodated therein.

Referring to FIG. 8, in the sixth embodiment of the present disclosure, a trench 140 is formed between a housing 10 and a pole piece 530. Specifically, in the present embodiment, as recessed grooves 530a are formed along the outer circumference of two pole pieces 531 and 532, a plurality of trenches 140 are formed.

Also, in the present embodiment, as in the third embodiment described above, the pole piece at which the blocking member 60 is provided may be formed smaller than the pole piece at which the blocking member is not provided, and accordingly, the overall size of the manufactured magnetic fluid seal may be small.

A magnetic fluid seal according to one embodiment of the present disclosure has advantageous effects that magnetic fluid loss can be prevented, a state thereof can be maintained, and sealing performance of the magnetic fluid seal can be improved just by a simple process of additionally placing a blocking member while maximally utilizing a structure of an existing magnetic fluid seal.

Advantageous effects of the present disclosure are not limited to those described above, and other unmentioned advantageous effects should be clearly understood by those of ordinary skill in the art to which the present disclosure pertains from this specification and the accompanying drawings.

The configurations and features of the present disclosure have been described above using the embodiments according to the present disclosure, but the present disclosure is not limited thereto, and it should be apparent to those of ordinary skill in the art, to which the present disclosure pertains, that various changes or modifications may be made within the spirit and scope of the present disclosure. Note that such changes or modifications fall within the scope of the attached claims.

DESCRIPTION OF THE REFERNCE NUMBER

| | |
|---|---|
| 10: housing | 20: rotating shaft |
| 30: pole piece | 40: trench |
| 50: magnetic fluid | 60: blocking member |
| 70: permanent magnet | |

1. A magnetic fluid seal comprising:
a rotating shaft;
a pole piece disposed to surround the rotating shaft;
a plurality of trenches formed on any one of the rotating shaft and the pole piece;
a magnetic fluid provided between the other one of the rotating shaft and the pole piece and at least one of ends of the plurality of trenches;
a blocking member provided in a space between the plurality of trenches; and
a permanent magnet configured to apply a magnetic force to the magnetic fluid.

2. The magnetic fluid seal of claim 1, wherein, in the space formed between the plurality of trenches, a size of a space where the blocking member is provided is formed larger than a size of another space.

3. The magnetic fluid seal of claim 1, wherein:
the pole piece includes a first pole piece and a second pole piece provided at both ends of the permanent magnet; and
the blocking member is provided between the first pole piece and the rotating shaft or between the second pole piece and the rotating shaft.

4. A magnetic fluid seal comprising:
a rotating shaft;
a pole piece disposed to surround the rotating shaft;
a plurality of trenches formed on any one of the rotating shaft and the pole piece;
a magnetic fluid provided on the other one of the rotating shaft and the pole piece and ends of the plurality of trenches;
a blocking member accommodation groove provided in at least one of the pole piece and the rotating shaft;
a blocking member provided in the blocking member accommodation groove; and
a permanent magnet configured to apply a magnetic force to the magnetic fluid.

5. A magnetic fluid seal comprising:
a rotating shaft;
a first pole piece disposed to surround the rotating shaft;
a second pole piece disposed to surround the rotating shaft;
a plurality of trenches formed on any one of the first pole piece and the rotating shaft;
a magnetic fluid provided on the other one of the first pole piece and the rotating shaft and ends of the plurality of trenches;
a blocking member accommodation groove provided in at least one of the second pole piece and the rotating shaft;
a blocking member provided in the blocking member accommodation groove; and
a permanent magnet configured to apply a magnetic force to the magnetic fluid.

6. A magnetic fluid seal comprising:
a housing;
a rotating shaft provided inside the housing;
a pole piece disposed to surround the rotating shaft;
a plurality of trenches formed on any one of the housing and the rotating shaft;
a magnetic fluid provided on the other one of the housing and the rotating shaft and ends of the trenches;
a blocking member provided in a space between the plurality of trenches; and
a permanent magnet configured to apply a magnetic force to the magnetic fluid.

7. A magnetic fluid seal comprising:
a housing;
a rotating shaft provided inside the housing;
a pole piece disposed to surround the rotating shaft;
a plurality of trenches formed on any one of the housing and the rotating shaft;
a magnetic fluid provided on the other one of the housing and the rotating shaft and ends of the trenches;
a blocking member accommodation groove provided in at least one of the housing and the rotating shaft;
a blocking member provided in the blocking member accommodation groove; and
a permanent magnet configured to apply a magnetic force to the magnetic fluid.

8. A magnetic fluid seal comprising:
a housing;
a rotating shaft provided inside the housing;
a first pole piece disposed to surround the rotating shaft;
a second pole piece disposed to surround the rotating shaft;
a plurality of trenches formed on any one of the first pole piece and the housing;
a magnetic fluid provided on the other one of the first pole piece and the housing and ends of the plurality of trenches;
a blocking member accommodation groove provided in at least one of the second pole piece and the housing;
a blocking member provided in the blocking member accommodation groove; and
a permanent magnet configured to apply a magnetic force to the magnetic fluid.
